(19) United States
(12) Patent Application Publication
(10) Pub. No.: US 2026/0189094 A1
(43) Pub. Date: Jul. 2, 2026

(54) SANDWICH-TYPE CONNECTION DEVICE FOR CONNECTING THE HOLLOW CONDUCTORS OF AN INTERNALLY COOLED ELECTRIC MACHINE AND ELECTRIC MACHINE COMPRISING A CONNECTION DEVICE OF THIS TYPE

(71) Applicant: DYNAMIC E FLOW GMBH, Valley (DE)

(72) Inventor: Markus Erlacher, Tuntenhausen (DE)

(21) Appl. No.: 19/128,003

(22) PCT Filed: Nov. 2, 2023
(86) PCT No.: PCT/EP2023/080565

§ 371 Date: May 7, 2025

(30) Foreign Application Priority Data
Nov. 8, 2022 (DE) 102022129442.0

(51) Int. Cl. H02K 3/28; H01R 9/18; H01R 9/24; H01R 105/00; H02K 3/22; H02K 3/24; H02K 3/50; H02K 15/38

(52) U.S. Cl. CPC H02K 3/28; H01R 9/18; H01R 9/2408; H02K 3/22; H02K 3/24; H02K 3/50; H01R 2105/00; H01R 2201/10; H02K 15/38

(57) ABSTRACT

The invention relates to a connection device (1) for the electrical and hydraulic connection of electrical hollow conductors (17) of an internally cooled electrical machine (23), comprising: an electrically conductive connection part (2) with one or more hollow conductor terminals (6); a side part (24) arranged on one side of the connection part (2) and a seal (5) arranged between the connection part (2) and the side part (24). According to the invention, at least two coolant channels (16) are integrated in the stack, via which a coolant can be fed into the hollow conductors (17) or coolant exiting from the hollow conductors (17) can be collected.

The invention relates to a connection device for the electrical and hydraulic connection of several electrical hollow conductors of an internally cooled electrical machine.

### BACKGROUND OF THE INVENTION

Various designs of internally cooled electrical machines with a winding formed from hollow conductors are known from the state of the art. The hollow conductors have an interior channel through which a coolant is passed in order to cool the electrical machine during operation.

The winding of well-known electrical machines usually consists of a thin hollow wire that is wound into coils. In other designs, the winding comprises rigid hollow conductors in the form of hairpins or pins. The pins or hairpins are rigid winding pieces made of copper, which are inserted into slots in the stator of the electrical machine and generate the magnetic field required for operating the electrical machine.

The hollow conductors have open ends through which a coolant can be fed into the hollow conductors or can exit from the hollow conductors. The known hollow conductors are provided with an electrically insulating layer on their exterior surface.

In the case of internally cooled electrical machines with hollow conductor windings, galvanic insulation of the hydraulic connection from the electrical supply potential poses a particular technical challenge. A known design of a hollow conductor connector in which galvanic insulation is achieved by means of a ceramic ball is described, for example, in EP 3 357 143 A2. Another hollow conductor connection piece comprising several components joined together to form a stack with an integrated coolant channel is known from WO 2015/150 556 A1.

### OBJECT OF THE INVENTION

It is an object of the present invention to create a connection device for the electrical and hydraulic connection of several electrical hollow conductors of an internally cooled electrical machine, which is simple in design and can be manufactured quickly and inexpensively.

This object is solved in accordance with the invention by the features specified in claim 1. Further embodiments of the invention are shown in the sub-claims.

According to the invention, a connection device for electrically and hydraulically connecting the electrical hollow conductors of an internally cooled electrical machine is proposed, comprising at least the following features:
an electrically conductive connection part with one or more hollow conductor terminals, to each of which a hollow conductor is electrically and hydraulically connected;
a side part arranged on one side of the connecting part; wherein the connecting part and the side part are separate components which are joined together to form a stack;
an internal coolant channel which extends through the connecting part, the coolant channel being hydraulically connected to the hollow conductor or hollow conductors so that a coolant exiting from the one or more hollow conductors can be collected in the coolant channel, or a coolant present in the coolant channel can be fed into the one or more hollow conductors.

Due to its modularity, the connection device can be easily adapted to the specified requirements and, depending on the number of electrical phases of the machine, configured with more or fewer electrical connection parts. The individual components (connection parts, seals, insulators) required for this only need to be integrated into the stack-like structure for this purpose:

In principle, a “side part” can be any component that is arranged on one side of the connection part and that is part of the stack-like structure. A side part can therefore be an insulator, a seal or another component. Other components, such as an insulator and/or another seal, can be arranged between the connection part and the side part.

The connection part is preferably made from metal, such as copper. The internal coolant channel preferably goes through the material.

The seal is preferably designed as a flat seal.

In a special embodiment of the invention, the connection device is formed as a stack arrangement which is closed at each of its end faces by an electrically insulating side part. Preferably, at least one of the end face side parts has a central coolant connection, via which a coolant can be fed into the coolant channel, or coolant exiting from the coolant channel can be discharged.

The direction in which the individual components of the connection device are stacked essentially extends along a straight line. Wedge-shaped components could also be used to create a curved, e.g. ring-shaped, or other geometry of the stack arrangement.

The individual components of the connection device, namely at least the connection part and the side part, are preferably plate-shaped.

The one or more hollow conductors connected to the connection part, in an area where they are connected, preferably point in a direction that is essentially transverse to a direction in which the connection part and the side part are stacked (stacking direction). The hollow conductor terminals are preferably all arranged on the same side of the stacking arrangement.

In a special embodiment, the connection device comprises at least one electrically conductive connection part and a seal. In this case, the aforementioned internal coolant channel preferably extends through the connection part and the seal.

In the case of a multiphase embodiment of the connection device, the latter accordingly comprises several connection parts arranged one next to one another, with at least one seal or insulator being arranged between each two connection parts arranged next to one another. In a special embodiment of the invention, at least one seal and one insulator can be arranged between two adjacent connection parts, for example. Consequently, a multiphase embodiment of the connection device has several connection parts arranged next to one another, several seals and possibly several side parts.

The said connection part preferably has a member for connecting an electrical phase (U, V, W), such as a terminal, a cable lug or the like.

In a special embodiment, the connection device has at least two integrated coolant channels via which a coolant can be fed into the hollow conductors or coolant exiting from the hollow conductors can be collected.

The connecting device may further comprise a clamping device by which the connecting part, the side part and possibly other components of the stacking arrangement are pressed against each other. In one embodiment of the invention, the clamping device may comprise one or more clamping bolts which extend through the connection device. Alternatively, the clamping device can also grip around the stacking arrangement in the manner of a clamp.

The individual stacked components of the connection device can also be glued together

The present invention also relates to an electrical machine with a hollow conductor winding and a connection device designed in stacked or sandwich technology for the electrical and hydraulic connection of the electrical hollow conductors.

### BRIEF DESCRIPTION OF DRAWINGS

The invention is explained in more detail below using the attached drawings as an example. It shows:

FIG. 1 a schematic view of a three-phase electrical machine with hollow wire windings known from the prior art;

FIG. 2 an embodiment of an electrical/hydraulic connection device for a three-phase electrical machine with star connection;

FIG. 3 a side view of a part of the electrical/hydraulic connection device of FIG. 2;

FIG. 4 a sectional view of an electrical/hydraulic connection device along a longitudinal axis of the connection device;

FIG. 5 an embodiment of an electrical/hydraulic connection device for a three-phase electrical machine with star connection, in which a part designed for the flow and a part designed for the return of the cooling circuit are arranged spatially separated from each other;

FIG. 6 an embodiment of an electrical/hydraulic connection device for a three-phase electrical machine with star connection, in which a part designed for the flow and a part designed for the return of the cooling circuit are combined in one unit.

### EMBODIMENTS OF THE INVENTION

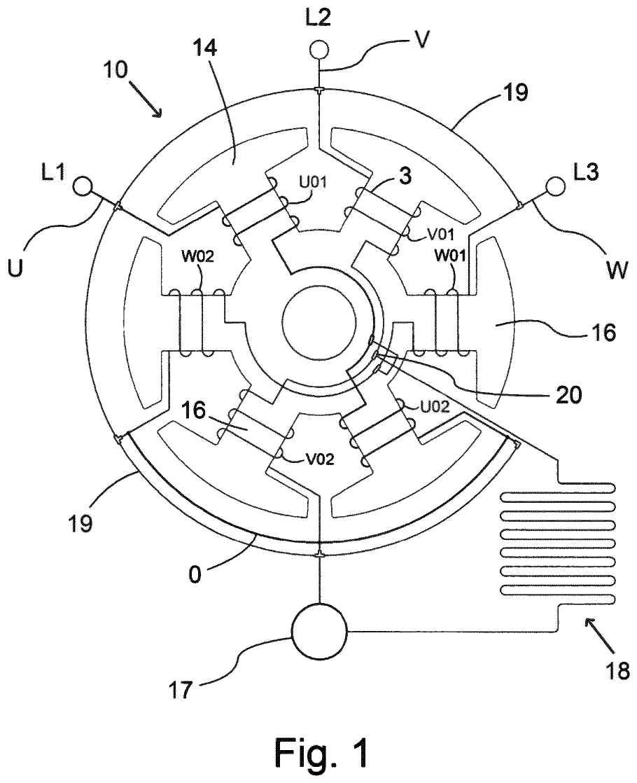

FIG. 1 shows a schematic view of a known three-phase synchronous machine 25 with an internal stator 24 and an external rotor (not shown). The electrical phases are labeled L1, L2 and L3 or 0 and are connected in a star connection.

The stator 24 comprises six teeth 20 on which the individual windings 18 are arranged. The windings 18 each consist of a hollow wire 17 through which a coolant flows in order to cool the electric motor 25 during operation. In the design example shown, coolant is supplied to the hollow wire ends of the individual windings 18 and at the star point 0 and is discharged again via internal, T-shaped connection pieces 26.

The synchronous machine shown in FIG. 1 also comprises a cooling system with a coolant pump 21 and a heat exchanger 22. The pump 21 pumps coolant through various coolant lines 19 to the phase-side ends of the windings 18, as well as to the neutral point 0, where the coolant enters the respective hollow conductors 17. The coolant then flows through the hollow conductors 17 and via the T-shaped connecting pieces 26 back towards the heat exchanger 22, where it is cooled and flows on to the pump 21.

The electrical and hydraulic connection of the individual hollow conductors 17 is a relatively complex solution for this electrical machine. An alternative connection device with a sandwich-like structure is therefore proposed, as shown as an example in the following figures. In principle, the connection device according to the invention can be used on all internally cooled electrical machines with one or more phases as well as on other internally cooled devices, such as electromagnets, valves, etc.

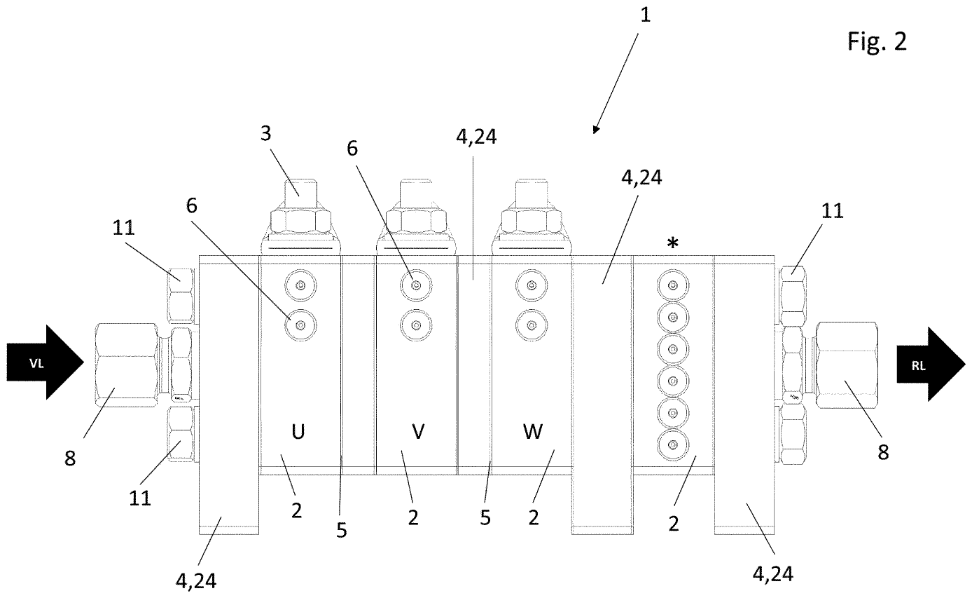

FIG. 2 shows an electrical/hydraulic connection device 1 for the hollow conductors 17 of an internally cooled electrical machine 25 according to a first embodiment of the invention. In this embodiment, the connection device 1 comprises four connection parts 2 arranged next to one another—one for each phase U, V, Wand one for the neutral point *—made from an electrically conductive material, such as Cu, to each of which the associated hollow conductors 17 are electrically and hydraulically connected. For this purpose, each connection part 2 comprises several hollow conductor terminals 6, to each of which an end of a hollow conductor is connected. The hollow conductor ends can, for example, be soldered or welded or otherwise fixed to the connection part 2. In addition, each connection part 2 comprises a terminal 3 to which one of the electrical phases (U, V, W or *) can be connected via a cable lug.

A first seal 5, an insulator 4 and a further seal 5 are each arranged between two adjacent connecting parts 2. The seals 5 are preferably designed as flat seals. An electrically insulating side part 24, which forms the end of the arrangement, is located at each of the two ends of the connection device 1 (left and right in the picture). The overall result is a stacked or sandwich-like structure.

In the embodiment shown here, the individual components 2, 4, 5, 24 of the stack arrangement are braced by means of a clamping device 11. As a result, the individual components 2, 4, 5, 24 are pressed against each other, which simultaneously seals the coolant channels 16 running inside. Such a connection device 1 can be easily assembled and, depending on the number of electrical phases or serial connections of the machine 25 to be contacted, configured with more or fewer connection parts 2. In addition to the phase connection, a connection part 2 can also be used to implement the electrical connection according to a specific winding scheme. In order to reduce the hydraulic pressure required for the flow through a coil, it is also possible to split a coil and electrically connect the coil parts in the connection part 2. The individual parts of the coil are then electrically connected in series, but can be supplied with coolant in parallel, which reduces the pressure required for flow.

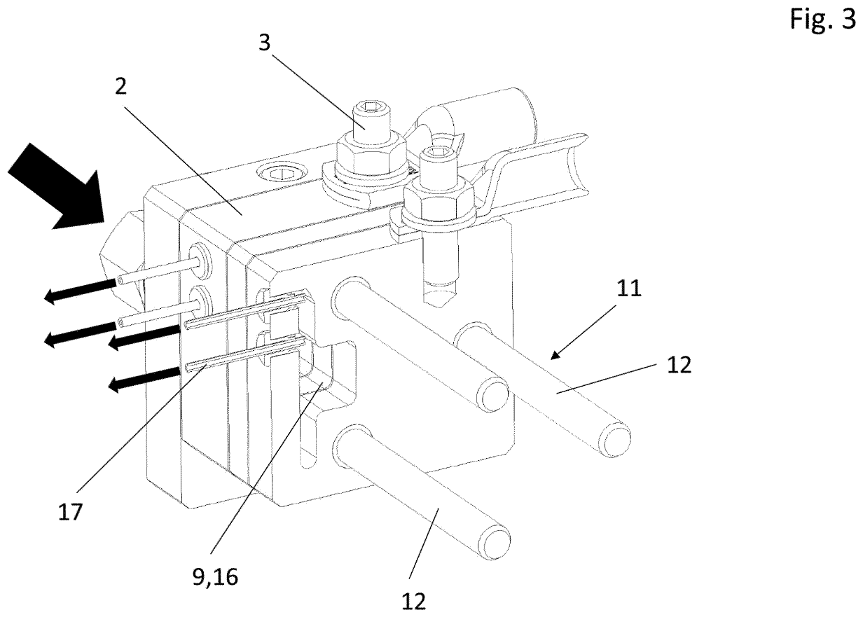

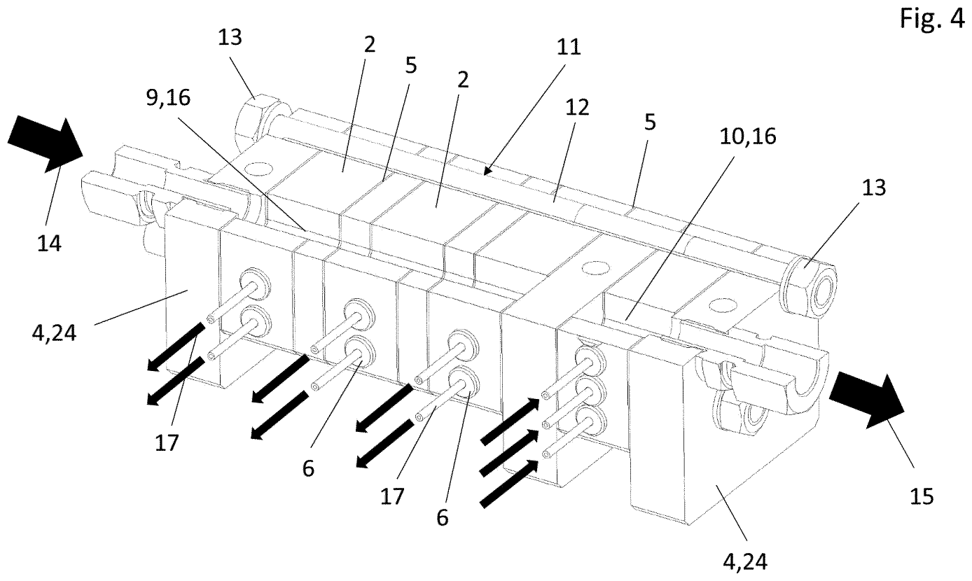

FIGS. 3 and 4 below show the internal structure of the connection device 1 and the clamping device 11 in more detail. FIG. 3 shows a side view of a part of the electrical/hydraulic connection device 1 of FIG. 2, and FIG. 4 shows a sectional view of the connection device 1 along a longitudinal axis of the connection device. As can be seen in FIGS. 3, 4, a first coolant channel 16 runs through the left-hand part of the sandwich-like structure, which is hydraulically connected to the hollow conductor terminals 6 of the connection parts 2 for the phases U, V, W. In the right-hand part of the connection device 1 there is another coolant channel 16, which is hydraulically connected to the hollow conductor terminals 6 of the connection part 2 for the neutral point *. The side parts 24 arranged at the ends each comprise a central coolant connection 8, via which coolant can be fed into the coolant ducts 16 or coolant exiting from the coolant ducts 16 can be drained off (see arrows VL, RL).

In the operating mode of the cooling circuit shown here, the left-hand coolant connection 8 shown in FIG. 4 serves as the coolant inlet (flow) and the right-hand coolant connection 8 as the coolant outlet (return). The left-hand coolant channel 16 is correspondingly a distributor channel 9, via which the coolant is fed into the individual hollow conductors 17 (see the arrows pointing outwards at the ends of the hollow conductors 17). The right-hand coolant duct 16 is correspondingly a collecting duct 10, in which the coolant exiting from the individual hollow conductors 17 is collected (see the arrows pointing inwards at the hollow conductor ends of the neutral point).

In this embodiment, the clamping device 11 comprises three clamping bolts 12 or threaded bolts that extend through the entire connection device 2. Nuts 13 are arranged at the projecting ends of the clamping bolts 12 and are used to tighten the device.

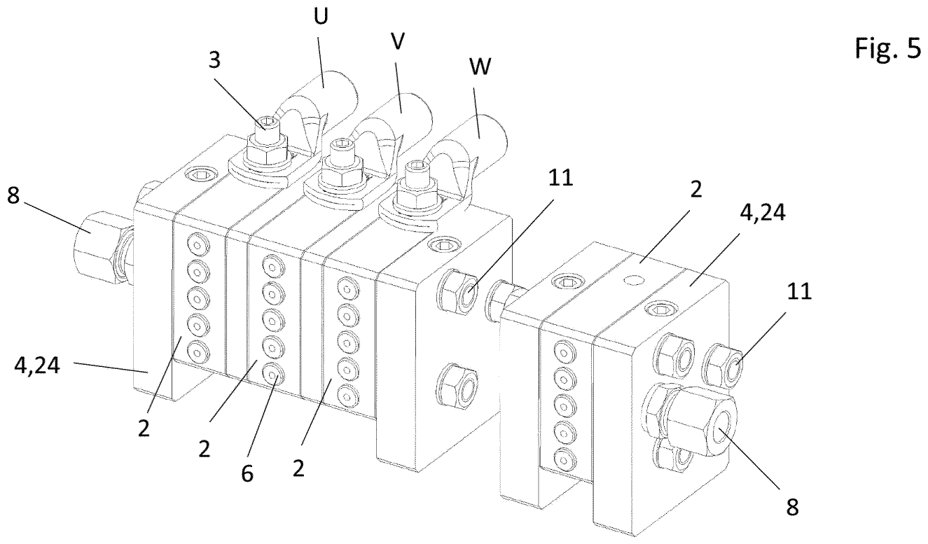

FIG. 5 shows an embodiment of an electrical/hydraulic connection device 1 for a three-phase electrical machine 25 with star connection, in which a part of the connection device 1 designed for the forward flow and a part designed for the return flow of the cooling circuit are arranged spatially separated from each other. In this case, the left-hand part comprises connection parts 2 for all three phases U, V, W, and the right-hand part comprises only one connection part 2 for the star point. The division of the connection device can also be designed differently.

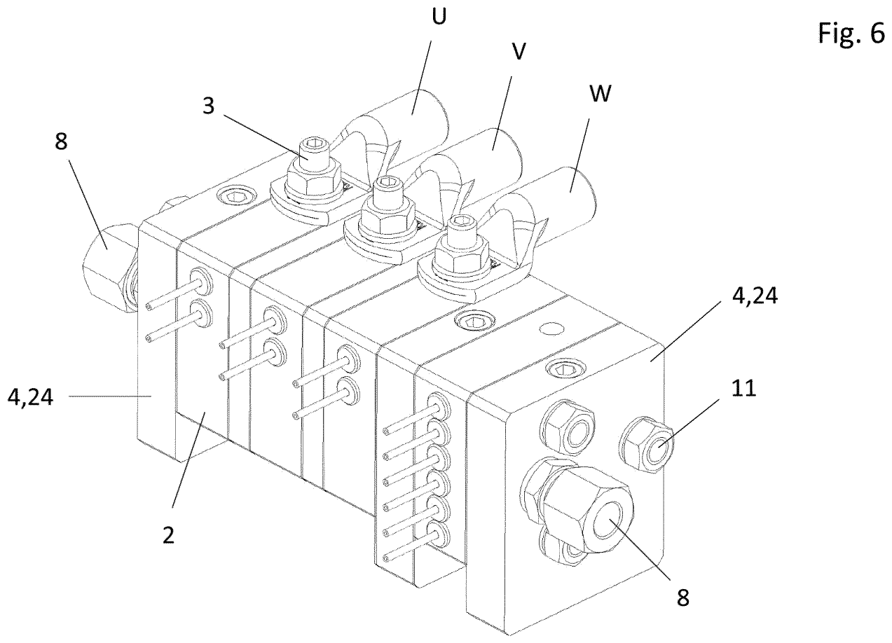

FIG. 6 shows another embodiment of an electrical/hydraulic connection device 1 for a three-phase electrical machine 25 with star connection, in which a part designed for the flow and a part designed for the return of the cooling circuit are combined in a single unit

1. A connection device for the electrical and hydraulic connection of electrical hollow conductors of an internally cooled electrical device, in particular an electrical machine, comprising:
at least one electrically conductive connection part with one or more hollow conductor terminals for connecting an end of one or more hollow conductors;
at least one electrically insulating side part arranged on one side of the connection part;
wherein the at least one connecting part and the at least one side part are arranged as a stack;
at least two coolant channels integrated in the stack, via which a coolant can be fed into the hollow conductors or coolant exiting from the hollow conductors can be collected, wherein the coolant channels extend substantially in a direction in which the connecting part and the side part are stacked.

2. A connection device according to claim 1, wherein the one or more hollow conductors are connected to the at least one connecting part in a direction which is substantially transverse to a direction in which the at least one connecting part and the at least one side part are stacked.

3. A connection device according to claim 1, wherein the connection device comprises a plurality of connecting parts arranged next to one another, at least one seal being arranged between each two connecting parts arranged next to one another.

4. A connection device according to claim 1, wherein the connection device is formed as a stack arrangement extending substantially along a straight axis.

5. A connection device according to claim 1, wherein the connection device is formed as a stack arrangement which is completed at opposing end faces thereof by an electrically insulating side part

6. A connection device according to claim 5, wherein at least one of the at least one side parts provides a central coolant connection via which a the coolant can be fed into the a coolant duct or coolant exiting from the coolant duct can be discharged.

7. A connection device according to claim 1, wherein a clamping device is provided, with which the at least one connecting part and the at least one side part and optional further components of the stacking arrangement are clamped against each other.

8. A connection device according to claim 1, wherein the at least one connection part has a terminal for connecting an electrical phase (U, V, W).

9. A connection device according to claim 7, wherein the clamping device comprises a clamping bolt which extends through the connecting device.

10. (canceled)

11. (canceled)
